(19) United States
(12) Patent Application Publication
(10) Pub. No.: US 2011/0185495 A1
(43) Pub. Date: Aug. 4, 2011

(54) Spreader Bar Device

(76) Inventors: Martin Robert-Jones, Hampshire (GB); John Greaves, Hampshire (GB)

(21) Appl. No.: 13/054,218

(22) PCT Filed: Jul. 13, 2009
(86) PCT No.: PCT/GB2009/001739

§ 371 Date: Apr. 13, 2011

(30) Foreign Application Priority Data
Jul. 14, 2008 (GB) 0812764.9

(51) Int. Cl. A61G 7/10

(52) U.S. Cl. 5/83.1

(57) ABSTRACT

A spreader bar device for a patient handling hoist includes a housing connectable to a hoist, a spool which is rotatably mounted on the housing, an elongate flexible hoist attachment element attachable to the hoist and which is extendably windable on the spool, opposing elongate spreader arms which extend from the housing, and a harness attachment element by which a patient harness is attachable to the spreader arms. The spreader arms are pivotable about the housing whereby an angular spacing between the longitudinal extents of the arms is adjustable so that the arms have a plurality of selectable working positions.

### RELATED APPLICATIONS

This application claims priority from PCT patent application PCT/GB2009/001739, entitled A SPREADER BAR DEVICE, filed Jul. 13, 2009, currently pending; PCT/GB2009/001739 claims priority from British application GB0812764.9, entitled a spreader bar device, filed Jul. 14, 2008.

### TECHNICAL FIELD

The present invention relates to a patient hoist and particularly but not exclusively to a patient hoist support from which a patient sling or harness can be supported.

### BACKGROUND OF THE INVENTION

It is known to provide a patient hoist, also known as a winch assembly or overhead motor, for lifting patients, for example in hospitals and care homes. Typically the patient hoist is attached to an overhead support, such as a ceiling mounted rail or a rail mounted on temporarily or permanently positioned floor to ceiling support posts. A support means is typically either attached to or integrated into the patient hoist and usually comprises a fixed horizontal support bar or arm disposed beneath the patient hoist, from which the straps of a sling or harness can be supported for supporting a patient.

To enable a patient harness or sling to more comfortably support a patient being lifted by the hoist, a spreader bar is often utilized to which the harness or sling is connected, and which itself is then connected to the hoist. The spreader bar allows the attachment points of the harness or sling to be positioned outwardly of the patient.

However, sizes of patients vary tremendously, and a spreader bar that provides comfortable harness or sling attachment point spacing for one person may be uncomfortable for another person. Further, it would be advantageous if improvements could be made in transporting or storing a spreader bar device, for example, when not needed, needed in a completely different location, or being purchased.

There is a need to provide a patient hoist with a spreader bar having improved functioning.

### SUMMARY OF THE INVENTION

According to this invention there is provided a spreader bar device for a patient handling hoist. The device includes a housing connectable to a hoist, a spool which is rotatably mounted on the housing, an elongate flexible hoist attachment element attachable to the hoist and which is extendably windable on the spool, opposing elongate spreader arms which extend from the housing, and a harness attachment element by which a patient harness is attachable to the spreader arms. The spreader arms are pivotable about the housing whereby an angular spacing between the longitudinal extents of the arms is adjustable so that the arms have a plurality of selectable working positions.

According to this invention there is also provided a spreader bar device for a patient handling hoist. The device includes a housing connectable to a hoist, a spool which is rotatably mounted on the housing, an elongate flexible hoist attachment element attachable to the hoist and which is extendably windable on the spool, opposing elongate spreader arms which extend from the housing, and a harness attachment element by which a patient harness is attachable to the spreader arms. The spreader arms are pivotable about the housing whereby an angular spacing between the longitudinal extents of the arms is adjustable so that the arms have a plurality of selectable working positions. Also included is a guide element which guides and entrains the hoist attachment element with the spool.

According to this invention there is also provided a spreader bar device for a patient handling hoist. The device includes a housing connectable to a hoist, a spool which is rotatably mounted on the housing, an elongate flexible hoist attachment element attachable to the hoist and which is extendably windable on the spool, opposing elongate spreader arms which extend from the housing, and a harness attachment element by which a patient harness is attachable to the spreader arms. The spreader arms are pivotable about the housing whereby an angular spacing between the longitudinal extents of the arms is adjustable so that the arms have a plurality of selectable working positions. Also included is a locator which releasably holds the spreader arms at a plurality of different angular positions relative to the housing.

Various advantages of this invention will become apparent to those skilled in the art from the following detailed description of the preferred embodiment, when read in light of the accompanying drawings.

### BRIEF DESCRIPTION OF THE DRAWINGS

FIG. 1 shows a perspective view of one embodiment of a spreader bar device, with the arms at a first operating condition;

FIG. 2 is a front view of the spreader bar device shown in FIG. 1, with the arms shown at a plurality of positions;

FIG. 3 is a view similar to FIG. 1, but with the arms at a storage condition;

FIGS. 4a to 4c show a bottom view of the spreader bar device and a first embodiment of locator for the arms;

FIG. 5 shows a second embodiment of locator for the arms; and

FIG. 6 shows a third embodiment of locator for the arms.

### DETAILED DESCRIPTION OF THE INVENTION

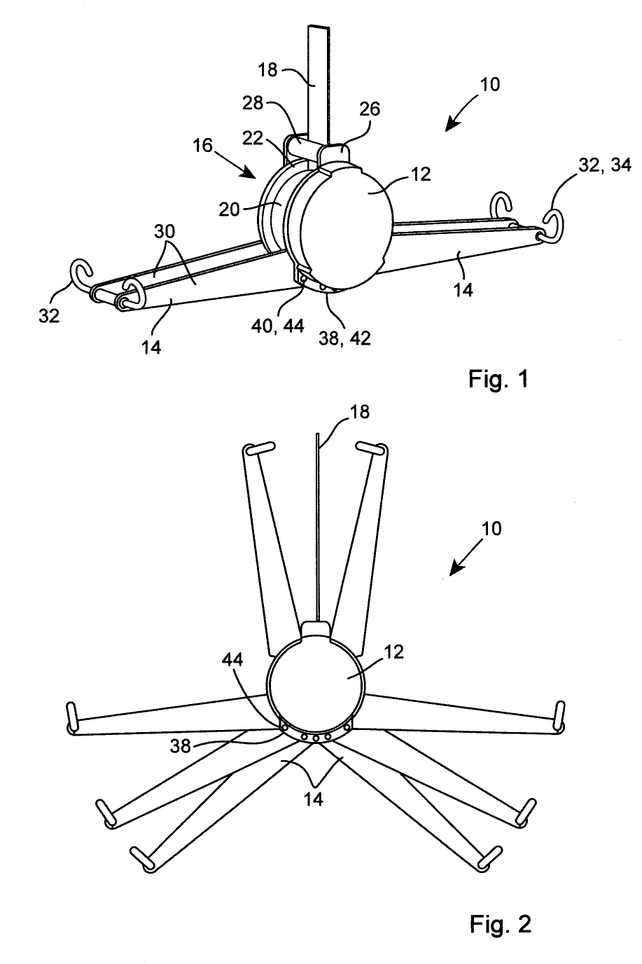

Referring to the drawings, there is shown a spreader bar device 10 which comprises a housing 12, and opposing elongate spreader arms 14 which extend from the housing 12. As shown, the housing 12 is circular, but it can be of any shape. The housing 12 includes a spool 16 onto which a tape or strap 18 can be wound and unwound. As such, the spool 16 comprises a cylindrical hub 20 with two, typically continuous, outwardly extending flanges 22 formed at or adjacent to ends of the hub 20. The hub 20 of the spool 16 may be open on the housing 12, as shown in FIG. 1, or enclosed within a housing cover. In the former option, a guide element 26 is provided on the housing 12 to guide and entrain the tape or strap 18 with the hub 20. The guide element 26 includes two parallel spaced-apart bars 28, which for example, may be rollers. The bars or rollers 28 span an axial length of the hub 20. The tape or strap 18 extends through the gap defined by the bars 28. In the latter option, a slot through which the tape or strap extends is formed in the housing cover.

Preferably, the hub 20 is motor-driven. To this end, an electric motor may, for example, be provided in the housing 12, and preferably within the hub 20. The motor may be temporarily disengagable from the tape or strap 18 to allow the tape or strap to freely run, thus allowing quicker length adjustment.

Each spreader arm 14 includes two spaced parallel arm members 30 which extend from the housing 12 and are positioned either side of the spool 16. The arms 14 are pivotably engaged with the housing 12 for rotation therearound. Beneficially, pivot axes of the arms 14 are coaxial, and also the pivot axes are coaxial with the rotational axis of the spool 16. As such, the tape or strap 18 extends from the housing 12 in a direction which is perpendicular or substantially perpendicular to the pivot axes. In one embodiment, each arm 14 can pivot in a range between 90 degrees and 180 degrees. An angular spacing between the arms 14 may be from or substantially from 0 degrees to 180 degrees.

In another embodiment, the elongate arms 14 are also motor-driven so that they can be easily repositioned. However, additionally or alternatively, the arms 14 may be manually movable by a user.

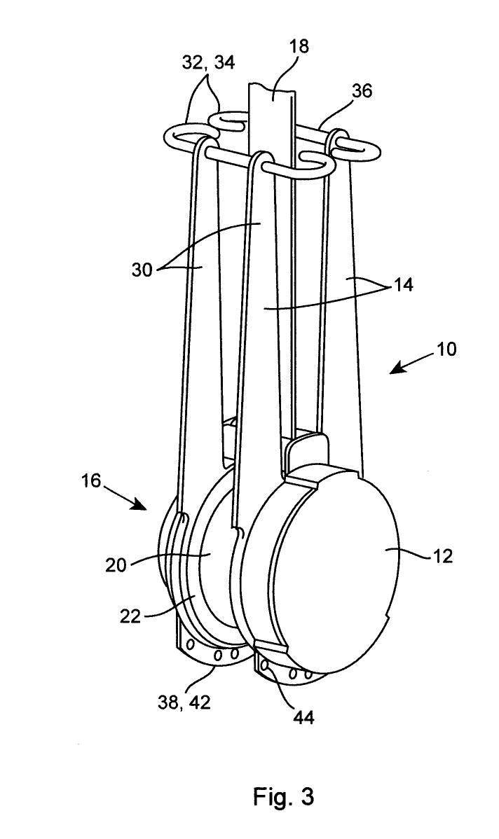

An attachment mechanism 32 for attaching a patient harness to the arms 14 is provided. In this case, a double hook 34 interconnects end portions of the arm members 30 of each arm 14. The hooks 34 are adapted to receive looped ends of attachment straps of a harness, and may include means for preventing unintentional release of the harness, such as spring-loaded closure elements, similar to those found on carabineers. The attachment 32 is positioned on each arm 14 such that, when the arms 14 are brought into close proximity, for example, for storage, the attachment 32 may abut or substantially abut, as shown in FIG. 3. Other forms of attachment can be used.

The attachment 32 also conveniently acts as a handle or grip 36, due to the length of the double hook 34 spanning the distance between the arm members 30. Thus, once the arms 14 are brought together or substantially together, the length of the double hooks 34 between the arm members 30 can be grasped in order to carry the spreader bar device 10.

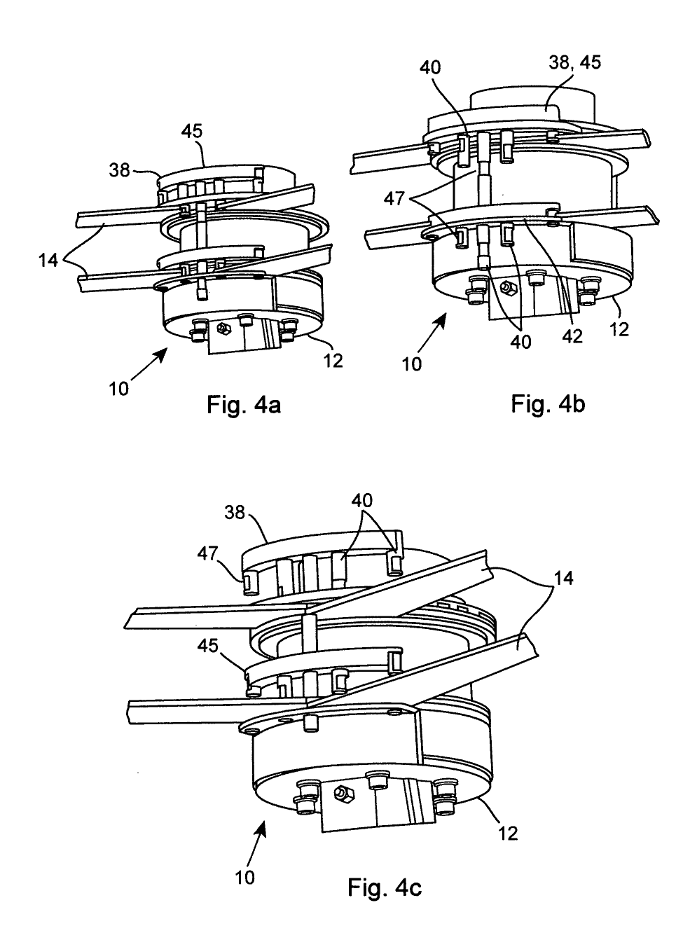

A locator 38 is also provided for preventing further rotational movement of the arms 14 in at least one direction. In this case, and with reference to FIGS. 4a to 4c, the locator 38 comprises a plurality of displaceable pins 40 for each arm, two opposing skirt portions 42 formed on lower opposing edges of the housing 12, and at least two apertures 44 per arm 14 formed in each skirt portion 42. In this case, three apertures 44 are provided per arm in each skirt portion 42, with one of the apertures 44 being common. In other embodiments, different configurations of the locator for preventing further rotation can be used.

The pins 40 associated with each skirt portion 42 are mounted on a common support element 45. The two common support elements 45 are interconnected via a central one of the pins 40. The common support elements 45 and peripheral pins 40 are symmetrically arranged around the central pin 40. The peripheral pins 40 have decreasing longitudinal extents towards the distal ends of the common support elements 45. As such, the pins 40 form a generally stepped configuration from the distal ends of the common support elements 45 to the central pin 40.

The central pin 40 is permanently and slidably received in the common apertures 44. The pins 40 are also notched to receive edges of the arms 14, to prevent dislodgement under load.

Dependent on the required angular spacing between the longitudinal extents of the arms 14, the necessary apertures 44 in the skirt portions 42 are selected and the corresponding pins 40 are inserted or retracted via movement of the common support elements 45 using a pushing and/or pulling force, as necessity dictates. The arms 14 are then rotated about the housing 12 until the arm members 30 abut their respective pins 40, and their edges are located in the respective notches 47.

The pins 40 thus act as stops. In the present embodiment, five apertures 44 are provided in each skirt portion 42, allowing the arms 14 to be symmetrically located at three different angular working positions. Means for retaining the pins once inserted can be used to improve safety. This is in addition to the notches 47.

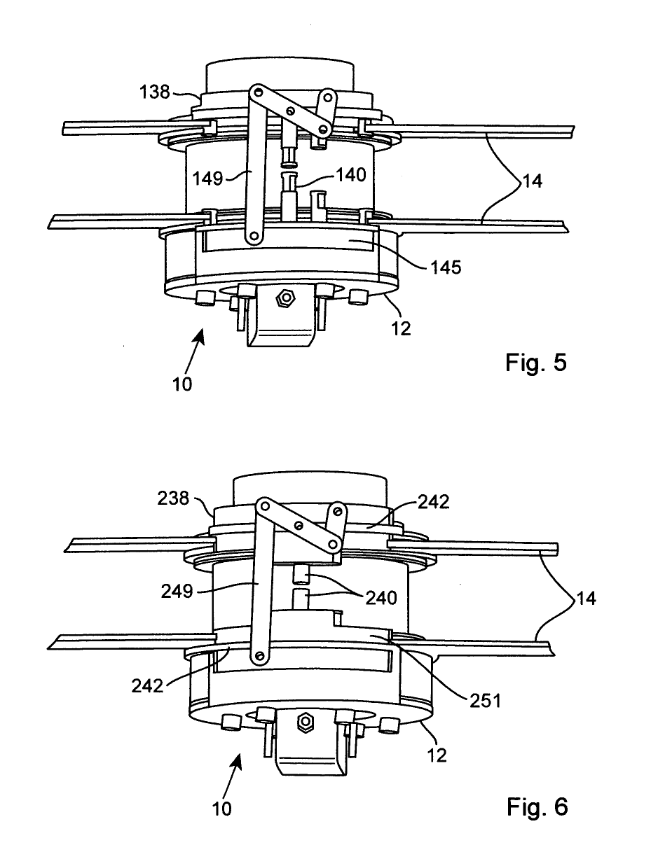

FIG. 5 shows a second embodiment of a locator 138. In this arrangement, instead of the central common pin, a pivotable mechanical linkage 149 is utilized to synchronously move the pins 140 and associated common support elements 145.

FIG. 6 shows a third embodiment of a locator 238. In this arrangement, only a central common pin 240 is utilized on each side, and the other previously described pins are substituted with a stepped block element 251 against edges of which the arms 14 can abut. Each common pin 240 and associated stepped block 251 are fixed relative to each other, and slide through the skirt portion 242, for example, via slides, tracks, channels and/or rails. Notches can again be provided to locate edges of the arms on abutment, and a pivotable mechanical linkage 249 can be utilized to synchronously move the common pins and associated stepped blocks.

Although the pins and stepped blocks act as stops, complementary openings in the arm members can be provided which are alignable with the apertures in the skirt portions. The pins can thus be inserted through the apertures and the aligned openings in the arm members in order to releasably fix the arms relative to each other and the housing.

Other locators can also be used. For example, a ratchet mechanism can be used. The locator may include one or more detents.

In use, the tape or strap 18 of the spreader bar device 10 is unwound from the housing hub 20 and connected to the free-standing hoist or ceiling hoist. The locator 38, 138, 238 is set, the arms 14 are then pivoted to the desired angular spacing, and the patient harness is attached. Following use, the arms 14 of the spreader bar device 10 are rotated upwards to abut or substantially abut, the device 10 is uncoupled from the hoist, and the tape or strap 18 is wound back onto the hub 20. The spreader bar device 10 can then be carried by the handle or grip 36 to a storage area or a different location for use.

In the case of the spreader bar device having either or both a motor-driven hub and/or motor-driven arms, a controller can be integrally provided on a surface of the housing, may be removable from the housing while being connected to internal circuitry in the housing via a data cable, or may be wirelessly connected to control circuitry in the housing.

It is possible that the locator can be dispensed with. In this case, for example, a clutch which prevents a reverse driving torque from being applied, thereby preventing the arms moving under the weight of the patient, can be used. Such a clutch may be a sprag clutch, for example, or similar device.

Furthermore, it is feasible that the motor may use a screw-threaded worm type arrangement to simultaneously drive the pivotable arms to the required angular spacing. Providing the motor and/or the worm can be locked, then the locator can be dispensed with. In this case, the arms can be positioned at an almost infinite number of relative angular positions around the housing.

The axial length of the hub may be increased to enable more than two arms to be provided. In this case, all of the arms may be pivotable. This may be beneficial for larger harnesses.

The attachment 36 may be provided at more than one position along the longitudinal extent of the arms, or may be provided at a position which is partway between ends of the arms, instead of at the end portions.

Although a tape or strap is suggested, any suitable elongate flexible element can be utilized to releasably attach the spreader bar device to the hoist. For example, a wire or cable can be employed. Although more bulky, a chain can also be used.

Although an elongate flexible element is preferred, in some cases, typically when using a free-standing hoist, it may be beneficial to provide a hoist attachment element which is shorter. In this case, a carabineer or hook which may be directly or substantially directly coupled with the housing can be provided.

Two arm members are suggested for each arm. However, an arm with a single arm member can be used. Furthermore, although the arms are rectilinear or substantially rectilinear and slightly taper towards their distal ends, they could be curved, with or without the taper.

As mentioned above, the angular spacing between the longitudinal extents of the opposing arms is adjustable to preferably at least three positions, being a storage position and two different working positions. However, the angular spacing can be adjustable to more than three positions, dependent on necessity. It is also possible that the angular spacing can be adjustable to only two positions, being a storage or transportation position and a single working position. In this latter case, the locator, if provided, may only require a single aperture per arm member.

In the above described embodiments, a longitudinal extent of the arms is fixed. However, it is feasible that the longitudinal extent of the arms can be adjustable. In this case, and by way of example only, the arms can be telescopic.

It is thus possible to provide a spreader bar device for a patient handling hoist which has pivotable spreader arms to which a patient harness or sling can be attached. An angular spacing between the longitudinal extents of the spreader arms is selectively adjustable depending on the type and size of harness or sling and the patient to be moved. The spreader arms can then be brought together or substantially together to enable easy carrying of the device by a user.

It is understood that variations may be made in the foregoing without departing from the scope of the invention. For example, the elements and teachings of the various illustrative embodiments may be combined in whole or in part in some or all of the illustrative embodiments. In addition, one or more of the elements and teachings of the various illustrative embodiments may be omitted, at least in part, and/or combined, at least in part, with one or more of the other elements and teachings of the various illustrative embodiments within the scope of the claims.

The principle and mode of operation of this invention have been described in its preferred embodiments. However, it should be noted that this invention may be practiced otherwise than as specifically illustrated and described without departing from its scope.

1-21. (canceled)

22. A spreader bar device for a patient handling hoist, the device comprising a housing connectable to a hoist, a spool which is rotatably mounted on the housing, an elongate flexible hoist attachment element attachable to the hoist and which is extendably windable on the spool, opposing elongate spreader arms which extend from the housing, and a harness attachment element by which a patient harness is attachable to the spreader arms, wherein the spreader arms are pivotable about the housing whereby an angular spacing between the longitudinal extents of the arms is adjustable so that the arms have a plurality of selectable working positions.

23. A spreader bar device as claimed in claim 22, wherein the spreader arms have a common or substantially common rotational axis.

24. A spreader bar device as claimed in claim 22, wherein the spreader arms and the spool have a common or substantially common rotational axis.

25. A spreader bar device as claimed in claim 22, wherein each spreader arm includes two spaced arm members which are on opposite sides of the spool.

26. A spreader bar device as claimed in claim 25, wherein the arm members of each arm are interconnected via the respective harness attachment element.

27. A spreader bar device as claimed in claim 22, wherein the arms are pivotably movable to extend in parallel or substantially parallel with each other.

28. A spreader bar device as claimed in claim 22, wherein the arms are pivotable so that the harness attachment element on each arm abut or substantially abut each other.

29. A spreader bar device as claimed in claim 28, wherein, when abutting or substantially abutting, the harness attachment elements form a handle for carrying the device.

30. A spreader bar device as claimed in claim 22, wherein the spreader arms are drivable by a motor housed in the housing.

31. A spreader bar device as claimed in claim 22, wherein the spool is drivable by a motor housed in the housing.

32. A spreader bar device as claimed in claim 22, wherein the in use hoist attachment element is extendable in a direction which is perpendicular or substantially perpendicular to the pivot axes of the arms.

33. A spreader bar device as claimed in claim 22, wherein the hoist attachment element is a tape or strap.

34. A spreader bar device for a patient handling hoist, the device comprising a housing connectable to a hoist, a spool which is rotatably mounted on the housing, an elongate flexible hoist attachment element attachable to the hoist and which is extendably windable on the spool, opposing elongate spreader arms which extend from the housing, and a harness attachment element by which a patient harness is attachable to the spreader arms, wherein the spreader arms are pivotable about the housing whereby an angular spacing between the longitudinal extents of the arms is adjustable so that the arms have a plurality of selectable working positions, and further including a guide element which guides and entrains the hoist attachment element with the spool.

35. A spreader bar device as claimed in claim 34, wherein the guide element includes two spaced guide bars.

36. A spreader bar device as claimed in claim 35, wherein the guide bars are rollers.

37. A spreader bar device as claimed in claim 34, wherein the hoist attachment element is substantially fully windable around the spool so as to be received within the housing for storage.

38. A spreader bar device as claimed in claim 34, wherein the housing includes a cover which covers the spool.

39. A spreader bar device for a patient handling hoist, the device comprising a housing connectable to a hoist, a spool which is rotatably mounted on the housing, an elongate flexible hoist attachment element attachable to the hoist and which is extendably windable on the spool, opposing elongate spreader arms which extend from the housing, and a harness attachment element by which a patient harness is attachable to the spreader arms, wherein the spreader arms are pivotable about the housing whereby an angular spacing between the longitudinal extents of the arms is adjustable so that the arms have a plurality of selectable working positions, and further including a locator which releasably holds the spreader arms at a plurality of different angular positions relative to the housing.

40. A spreader bar device as claimed in claim 39, wherein the locator includes at least one of a movable pin and a block element.

41. A spreader bar device as claimed in claim 39, wherein the locator includes a synchronous linkage.
